(19) United States
(12) Patent Application Publication
(10) Pub. No.: US 2025/0146654 A1
(43) Pub. Date: May 8, 2025

(54) COVER SYSTEM FOR LIGHT POLE FOOTINGS

(71) Applicant: Jason Schumacher, Tea, SD (US)

(72) Inventor: Jason Schumacher, Tea, SD (US)

(21) Appl. No.: 18/386,534

(22) Filed: Nov. 2, 2023

(51) Int. Cl. F21V 23/00; F21S 8/08; F21V 17/06; F21V 17/16

(52) U.S. Cl. CPC F21V 23/002; F21S 8/085; F21V 17/06; F21V 17/168

(57) ABSTRACT

A cover system for covering exposed wiring from downed light poles includes a casing assembly with a shell, a flange, and a base ring. The shell fits over a light pole footing through which wiring may be otherwise exposed, and the base ring weighs the shell down via engagement with the flange. A method of covering light pole footings with such a cover system is also disclosed.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to cover apparatuses and more particularly pertains to a new cover apparatus for covering exposed wiring from downed light poles.

### (2) Description of Related Art Including Information Disclosed Under 37 CFR 1.97 and 1.98

When light poles for streetlights are removed from their footings, either via intentional dismantling or destruction from vehicle collisions or the like, the wiring which electrically attached to the streetlights becomes exposed to the environment and can post a hazard to passersby. The prior art discloses enclosures which store wiring or various light pole accessories between a light pole and a footing to which the light pole is to be mounted. The enclosures often act to mount the light pole to the footing in addition to storing wiring and accessories. The prior art however does not disclose a cover apparatus which may be deployed to cover wiring exposed due to downed light poles. Such an apparatus would be advantageous in preventing exposure to the hazard of exposed, electrically charged wires. An apparatus which may be quickly an simply deployed over a light pole footing, which does not significantly cause obstruction, and which effectively remains in place over the light pole footing is therefore needed.

### (h) BRIEF SUMMARY OF THE INVENTION

An embodiment of the disclosure meets the needs presented above by generally comprising a casing assembly comprising a shell, a flange, and a base ring. The shell defines a cavity therein with an opening at a bottom end of the shell. The opening has a size such that the opening is configured to receive a light pole footing. The flange is coupled to the shell at the bottom end and extends outwardly from the shell. The base ring is positionable over the flange and is weighted to retain the shell unless a sufficient force to lift the base ring is applied to the shell.

Another embodiment of the disclosure includes a method of shielding wires which protrude from the light pole footing using the casing assembly. The shell is positioned on a ground surface around the light pole footing. The shell is weighed down, typically though not necessarily via the base ring, to prevent the shell from being moved from around the light pole footing.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a casing assembly of a cover system according to an embodiment of the disclosure.

FIG. 2 is a front view of a casing assembly of an embodiment of the disclosure.

FIG. 3 is a cross-sectional in-use view of a casing assembly of an embodiment of the disclosure taken from Arrows 3-3 in FIG. 2.

FIG. 4 is an exploded view of an embodiment of the disclosure.

FIG. 5 is a top perspective view of an embodiment of the disclosure in a nested configuration.

FIG. 6 is a front view of an embodiment of the disclosure in a nested configuration.

FIG. 7 is a cross-section view of an embodiment of the disclosure taken from Arrows 7-7 in FIG. 6.

FIG. 8 is an in-use exploded view of a casing assembly of an embodiment of the disclosure.

### (j) DETAILED DESCRIPTION OF THE INVENTION

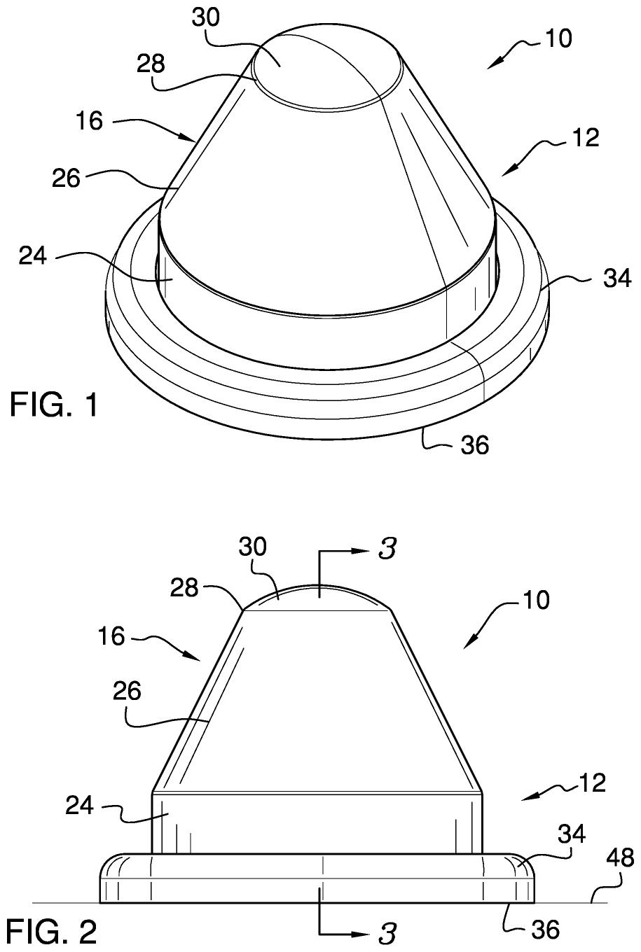

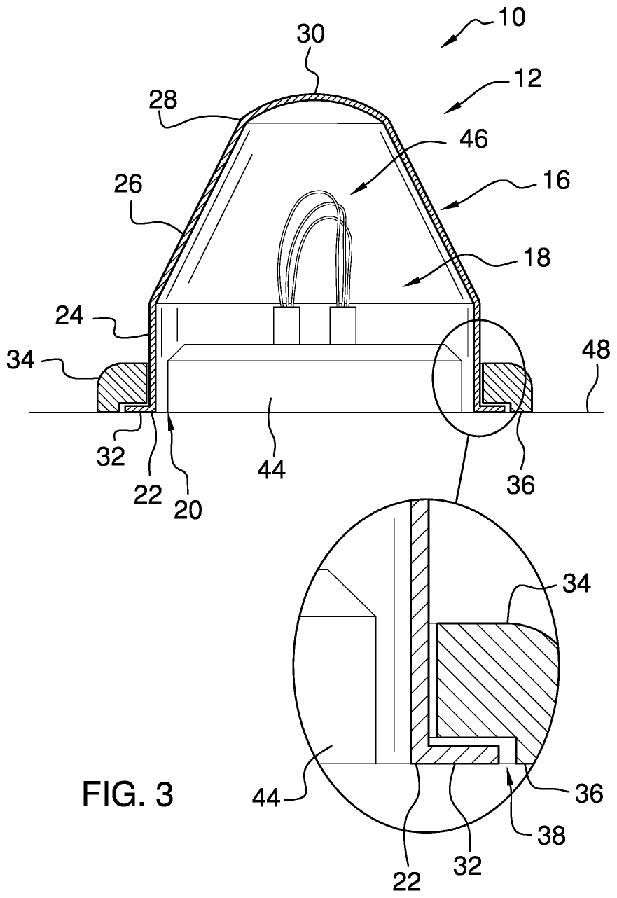

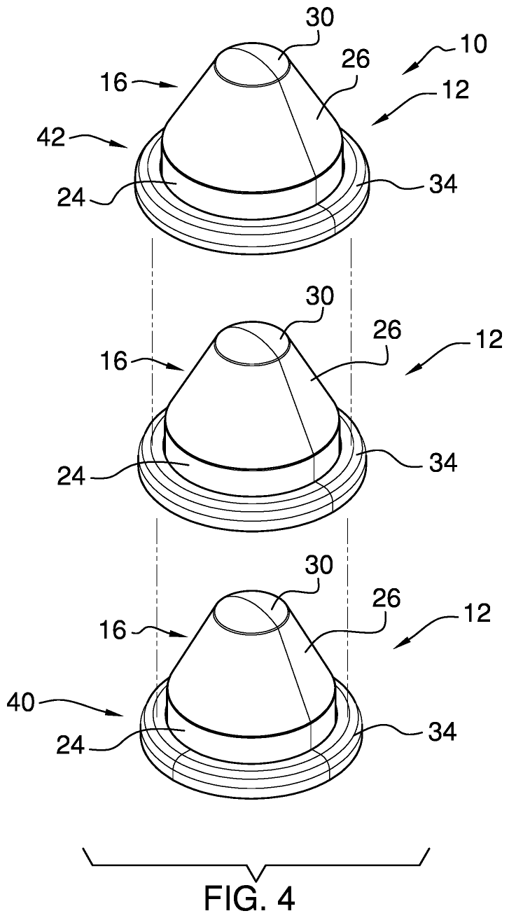

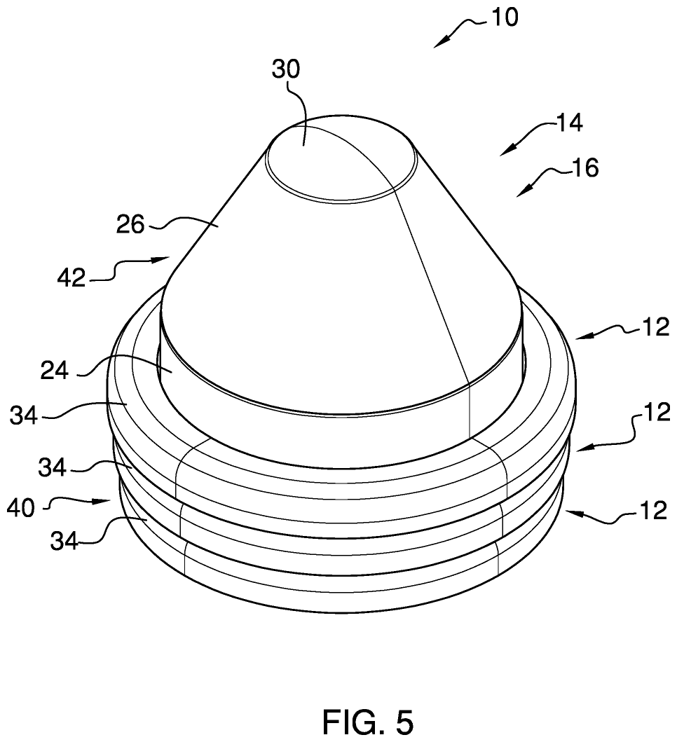

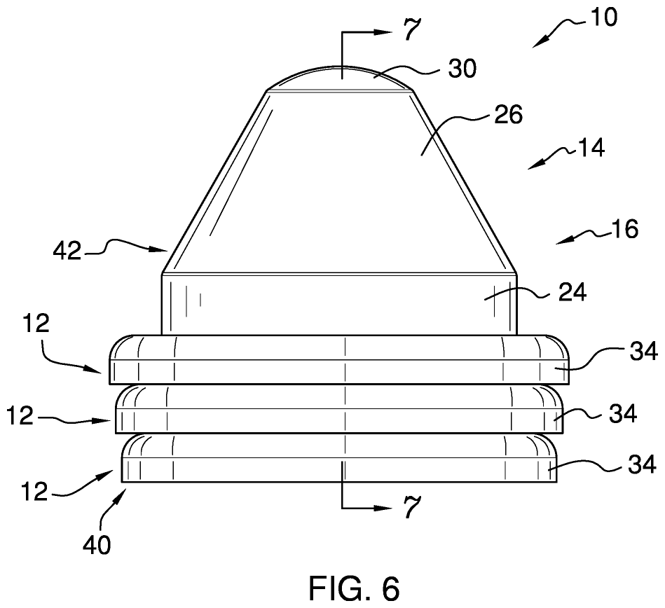

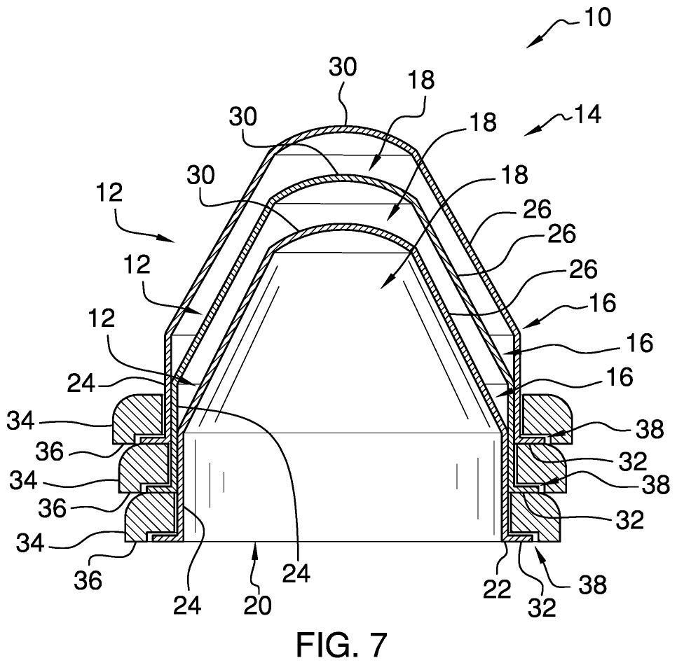

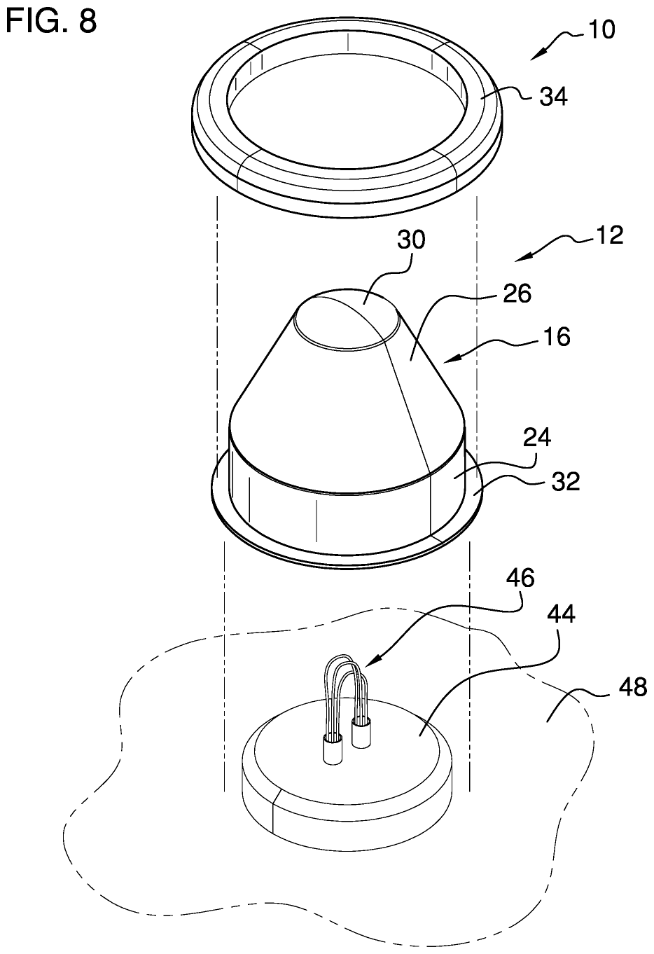

With reference now to the drawings, and in particular to FIGS. 1 through 8 thereof, a new cover apparatus embodying the principles and concepts of an embodiment of the disclosure and generally designated by the reference numeral 10 will be described.

As best illustrated in FIGS. 1 through 8, the cover system 10 generally comprises a plurality of casing assemblies 12 which are stackable in a nested configuration 14. Each casing assembly 12 of the plurality of casing assemblies 12 comprises a shell 16, a flange 32, and a base ring 34. The shell 16 defines a cavity 18 therein with an opening 20 at a bottom end 22 of the shell 16. The opening 20 has a size such that the opening 20 is configured to receive a light pole footing 44.

The shell 16 comprises a constant width portion 24 which is positioned adjacent to the bottom end 22 of the shell 16 and defines the size of the opening 20. The constant width portion 24 has a height such that the constant width portion 24 extends above the light pole footing 44 when the shell 16 is placed on a ground surface 48 around the light pole fitting. The constant width portion 24 has a cylindrical shape but may have other suitable shapes such as a rectangular or octagonal shell 16. A converging portion 26 of the shell 16 is coupled to and extends upwardly from the constant width portion 24. The converging portion 26 converges inwardly from the constant width portion 24 toward a distal end 28 of the converging portion 26 with respect to the constant width portion 24. The converging portion 26 has a conical shape but may have a pyramidal shape or other suitable shape. A closed end portion 30 of the shell 16 is coupled to the distal end 28 of the converging portion 26 and closes the shell 16 distally from the opening 20. The closed end portion 30 has a dome shape which facilitates increased strength of the shell 16 compared to other shapes. The closed end portion 30 may have other suitable shapes such as a planar shape, a conical shape, a pyramidal shape, or the like. The shell 16 has a unitary structure and may be formed by a molding process. The shell 16 may comprise an electrically insulating material to prevent transmission of electricity through the shell 16 from wires 46 protruding through the light pole footing 44. In other embodiments, the constant width portion 24, the converging portion 26, and the closed end portion 30 are separately formed from each other.

The flange 32 coupled to the shell 16 at the bottom end 22 and extends outwardly from the shell 16. The flange 32 is integrally formed with the shell 16 but may be separately formed in other embodiments. The base ring 34 is positionable over the flange 32 and is weighted to retain the shell 16 unless a sufficient force to lift the base ring 34 is applied to the shell 16. The base ring 34 defines a groove 38 in a bottom surface 36 of the base ring 34 to accommodate the flange 32 when the base ring 34 is placed on the ground surface 48 around the flange 32. The base ring 34 may comprise rubber or any material suitable to weight the shell 16 down. A handle may also be attached to the shell 16 to facilitate grasping the shell 16, and the handle may, for example, be positioned on the closed end portion 30. The handle may also be integrally formed with the shell 16.

The opening 20 of the shell 16 of each casing assembly 12 except a bottommost casing assembly 40 of the plurality of casing assemblies 12 has size sufficient for receiving the constant width section of the shell 16 of an adjacent casing assembly 12 of the plurality of casing assemblies 12. The sizes of the openings 20 of the shells 16 therefore facilitates positioning the casing assemblies 12 in the nested configuration 14 in which the constant width portions 24 of the shells 16 get progressively larger from a bottommost casing assembly 40 to a topmost casing assembly 42. The constant width portions 24 abut each other when the casing assemblies 12 are positioned in the nested configuration 14, and the base rings 34 lie on top of each other.

In use, the casing assemblies 12 may be stored in the nested configuration 14 and may, for example, be stored on a vehicle. To shield the wires 46 which protrude from the light pole footing 44, one of the casing assemblies 12 is selected and removed from the stack of casing assemblies 12 and positioned over the light pole footing 44. The shell 16 and the base ring 34 of the selected casing assembly 12 may be positioned simultaneously on the ground surface 48 or in stages or steps. The constant width portion 24 of the shell 16 ensures that the shell 16 does not interfere with the light pole footing 44 during placement. The converging portion 26 of the shell 16 extends upwardly from the constant width portion 24 to provide room for the wires 46 protruding through the light pole footing 44 and converges inwardly to avoid interaction with wind, passersby, or other forces which may cause the selected casing assembly 12 to fall over.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present. unless the context clearly requires that there be only one of the elements.

I claim:

1. A cover system for shielding wires protruding from a light pole footing, the system comprising a casing assembly, the casing assembly comprising:
a shell defining a cavity therein with an opening at a bottom end of the shell, the opening having a size such that the opening is configured to receive the light pole footing;
a flange coupled to the shell at the bottom end, the flange extending outwardly from the shell; and
a base ring which is positionable over the flange, the base ring being weighted to retain the shell unless a sufficient force to lift the base ring is applied to the shell.

2. The system of claim 1, wherein the shell comprises a constant width portion positioned adjacent to the bottom end of the shell, the constant width portion defining the size of the opening, the constant width portion having a height such that the constant width portion extends above the light pole footing when the shell is placed on a ground surface around the light pole footing.

3. The system of claim 2, wherein the constant width portion has a cylindrical shape.

4. The system of claim 2, wherein the shell further comprises a converging portion coupled to and extending upwardly from the constant width portion, the converging portion converging inwardly from the constant width portion toward a distal end of the converging portion with respect to the constant width portion.

5. The system of claim 4, wherein the converging portion has a conical shape.

6. The system of claim 4, wherein the shell further comprises a closed end portion, the closed end portion being coupled to the distal end of the converging portion.

7. The system of claim 6, wherein the closed end portion has a dome shape.

8. The system of claim 1, wherein the base ring defines a groove in a bottom surface of the base ring to accommodate the flange when the base ring is placed on the ground surface around the flange.

9. The system of claim 1, wherein the casing assembly is one of a plurality of casing assemblies, the casing assemblies being stackable in a nested configuration, each casing assembly of the plurality of casing assemblies comprising:
a shell defining a cavity therein with an opening at a bottom end of the shell, the opening having a size such that the opening is configured to receive the light pole footing;
a flange coupled to the shell at the bottom end, the flange extending outwardly from the shell; and
a base ring which is positionable over the flange, the base ring being weighted to retain the shell unless a sufficient force to lift the base ring is applied to the shell.

10. The system of claim 9, wherein the shell of each casing assembly comprises a constant width portion positioned adjacent to the bottom end of the shell, the constant width portion defining the size of the opening, the constant width portion having a height such that the constant width portion extends above the light pole footing when the shell is placed on a ground surface around the light pole footing.

11. The system of claim 10, wherein the opening of the shell of each casing assembly except a bottommost casing assembly of the plurality of casing assemblies has a size sufficient for receiving the constant width section of the shell of an adjacent casing assembly of the plurality of casing assemblies.

12. A cover system for shielding wires protruding from a light pole footing, the system comprising:
a plurality of casing assemblies, the casing assemblies being stackable in a nested configuration, each casing assembly of the plurality of casing assemblies comprising:
a shell defining a cavity therein with an opening at a bottom end of the shell, the opening having a size such that the opening is configured to receive the light pole footing, the shell comprising:
a constant width portion positioned adjacent to the bottom end of the shell, the constant width portion defining the size of the opening, the constant width portion having a height such that the constant width portion extends above the light pole footing when the shell is placed on a ground surface around the light pole footing, the constant width portion having a cylindrical shape;
a converging portion coupled to and extending upwardly from the constant width portion, the converging portion converging inwardly from the constant width portion toward a distal end of the converging portion with respect to the constant width portion, the converging portion having a conical shape; and
a closed end portion, the closed end portion being coupled to the distal end of the converging portion, the closed end portion having a dome shape;
wherein the shell has a unitary structure;
a flange coupled to the shell at the bottom end, the flange extending outwardly from the shell, the flange being integrally formed with the shell; and
a base ring which is positionable over the flange, the base ring being weighted to retain the shell unless a sufficient force to lift the base ring is applied to the shell, the base ring defining a groove in a bottom surface of the base ring to accommodate the flange when the base ring is placed on the ground surface around the flange;
wherein the opening of the shell of each casing assembly except a bottommost casing assembly of the plurality of casing assemblies has a size sufficient for receiving the constant width section of the shell of an adjacent casing assembly of the plurality of casing assemblies.

13. A method of shielding wires which protrude from a light pole footing, the method comprising:
positioning a shell on a ground surface around the light pole footing, wherein the shell is shaped to extend over the light pole footing and the wires which protrude from the light pole footing; and
weighing the shell down to the ground.

14. The method of claim 13, wherein the shell has a constant width portion which extends upwardly beyond the light pole footing from the ground surface.

15. The method of claim 14, wherein the shell has a converging portion which extends upwardly and converges inwardly from the constant width portion.

16. The method of claim 13, wherein the step of weighing the shell down comprises positioning a base ring over a flange coupled to the shell, wherein the shell is coupled to and extends outwardly from the shell.
